(19) United States
(12) Patent Application Publication
(10) Pub. No.: US 2003/0092381 A1
(43) Pub. Date: May 15, 2003

(54) Modular satellite communications equipment

(76) Inventors: Claude Buel, Springfield, VA (US); Melvin W. Clarke, Vienna, VA (US); Thien Nguyen, South Riding, VA (US); Nicholas Hickman, Germantown, MD (US); Warner White, Herndon, VA (US)

Correspondence Address: SCHNADER HARRISON SEGAL & LEWIS, LLP, 1600 MARKET STREET, SUITE 3600, PHILADELPHIA, PA, 19103

(21) Appl. No.: 10/232,186

(22) Filed: Aug. 29, 2002

Related U.S. Application Data
(60) Provisional application No. 60/316,610, filed on Aug. 31, 2001.

(51) Int. Cl. H04B 7/185

(52) U.S. Cl. 455/13.1; 455/12.1

(57) ABSTRACT

A modular satellite terminal communications system, adaptable to a variety of applications by adding or removing modules. In addition, a computer readable medium and methods for automatically connecting the modular components in functional communication with one another. Signals are automatically routed to the components chosen for the system, and rerouted when modules are removed or added to the system.

### CROSS-REFERENCE TO RELATED APPLICATIONS

This application claims the benefit of U.S. provisional patent application Serial No. 60/316,610 filed Aug. 31, 2001.

### BACKGROUND OF THE INVENTION

1. Field of the Invention

The invention relates to satellite terminal communications equipment, and more particularly, to portable satellite communications equipment.

2. Description of the Prior Art

Satellite terminal communications equipment may contain a number of components, such as a terminal, cellular phone, printer, facsimile, power supply and battery back-up system. Depending on the application, some or all of the components may be required. Typically, a portable communications unit is customized for the user's needs. To optimize portability, the user may incorporate the minimum number of components to provide the functions desired. It may be necessary, therefore, for a user to purchase more than one portable unit for different applications, which can be very costly. Additionally, if any single component malfunctions, the entire unit may be rendered unusable.

In conventional systems, the components must be connected manually to one another to be in functional communication, and are typically hard-wired to one another. To reconfigure the equipment with different components, existing components must be disconnected and new components hard-wired. This is a time consuming, and therefore costly process. Traditional satellite communications equipment requires an external power source. If such lines or sources are down or otherwise unavailable, the equipment cannot be utilized.

Therefore, a need exists for portable satellite terminal communications equipment that can be used for a wide variety of applications, is economical, and may be used during power outages.

### SUMMARY OF THE INVENTION

Embodiments of the present invention include modular satellite terminal communications equipment. The equipment may be easily adapted to a variety of applications by adding or removing modules.

Embodiments of the invention further include software and methods for automatically connecting the modular components in functional communication with one another. Signals are automatically routed to the components chosen for the system, and rerouted when modules are removed or added to the system.

### BRIEF DESCRIPTION OF THE DRAWINGS

The invention is best understood from the following detailed description when read with the accompanying drawings.

FIG. 1 depicts a modular satellite communications system according to an illustrative embodiment of the invention.

FIGS. 2A-D show liquid crystal display screens according to illustrative embodiments of the invention.

FIG. 3 depicts a flowchart for a power monitor function according to an illustrative embodiment of the invention.

FIG. 4 depicts a flowchart for actions in a power monitor menu system according to an illustrative embodiment of the invention.

FIG. 5 depicts a flowchart of actions for a controller according to an illustrative embodiment of the invention.

FIGS. 6A-F depict display shots for an on-screen control program according to an illustrative embodiment of the invention.

FIG. 7 depicts logic levels for a VOC controller.

FIGS. 8A-K depict electrical schematics according to illustrative embodiment of the invention.

FIG. 9 depicts a modular satellite communications system according to a further illustrative embodiment of the invention.

### DETAILED DESCRIPTION OF THE INVENTION

Embodiments of the present invention provide a modular satellite communications system that allows easy customization, and re-customization of the equipment for a variety of communication tasks. The equipment may contain a power supply to provide power and isolation for particular modular components of the system. In an illustrative embodiment of the invention the power supply has a display and control panel that provide status information about the power supply. The display and control panel may also provide a means of manual control, or override, of communication paths within the system.

Embodiments of the invention provide commonality of satellite terminal communications components housed in a common case or frame, wherein the common case or frame provides basic housekeeping needs for any of the modular inserts.

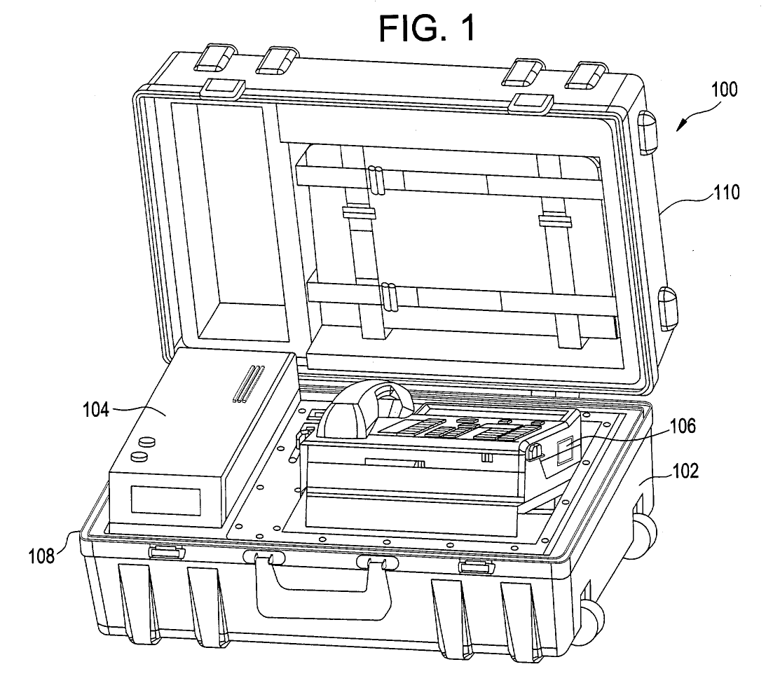

FIG. 1 depicts an illustrative embodiment of a modular satellite communications system 100. A common case 102 may accommodate numerous modules that may be plugged into the case or other components. Case 102 houses a universal power and management system 104, which is compatible with any number of modules that perform satellite communication functions. FIG. 1 shows a secure voice communications module 106. Case 102 includes base 108 and lid 110. Lid 110 may house, for example, a satellite communications terminal. Any satellite communications equipment component found in traditional portable and stationary systems may be incorporated as a module in the present invention. It is also possible for one or more components to be incorporated into a single module. Illustrative module component functions include voice and/or video, for example as used for video teleconferencing (VTC), data and/or facsimile communication, and military satellite (MILSAT) connectivity. Modules may also include a secondary power battery for extended field operations of any of the configured modules, future narrow band digital terminal (FNBDT), laptop, printer or other terminal. Data and facsimile communications may be provided via a computer, such as a laptop.

Both wired and wireless communications are within the scope of the invention. Wireless may include, but is not limited to, cellular technology such as a global system for modular communication (GSM), international maritime satellite (INMARSAT), and tactical satellite (TACSAT) radio. Communications may be either secure or non-secure. Security may be provided by government approved and/or commercial encryption devices. Embodiments of the invention may include broadband and narrowband transmissions.

In an exemplary embodiment of the invention a common case, houses universal power conditioning and management components, a power supply such as basic batteries for limited operation, and software to automatically and cooperatively connect system modules. Optionally, a power back-up and liquid crystal display (LCD) screen may be included. The common case may also house a satellite terminal such as an INMARSAT M-4 terminal. In an illustrative embodiment, the common case includes a base and lid, both of which may house components.

Embodiments of the invention further include an on screen control program (OSCP) which is software that manages a relay controller, referred to herein as a virtual office controller (VOC) relay bank, for automatically reconfiguring equipment components so that they may be operational and perform desired communication tasks. The relay bank is preferably contained in a system module. The relays switch the communication links internally for serial data buses, such as RS232, RS530 and ISDN data buses, with external connections to modular components such as a secure telephone unit, encryption device or other module.

An LCD may be incorporated in the system to display the status of information to the operator. In an illustrative embodiment of the invention, the LCD displays information regarding the power supply and the VOC. This may be accomplished by connecting a 2-wire communication path when the two units are installed in the package. Preferably, the power supply status-display is used with all inserts. The OSCP switching function is available when the computer module is incorporated into the system. Manual control of the relay set may be provided as a back-up or manual override of the normal OSCP functions to provide redundancy in the event the computer is not available.

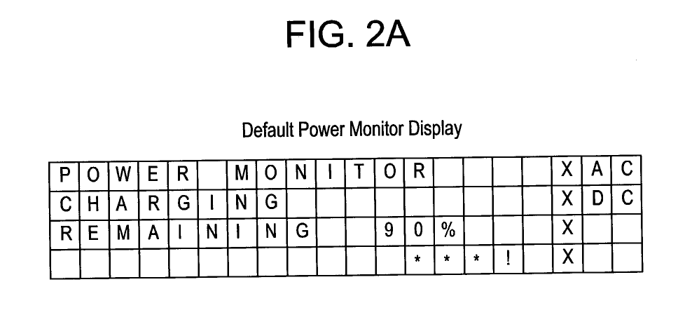

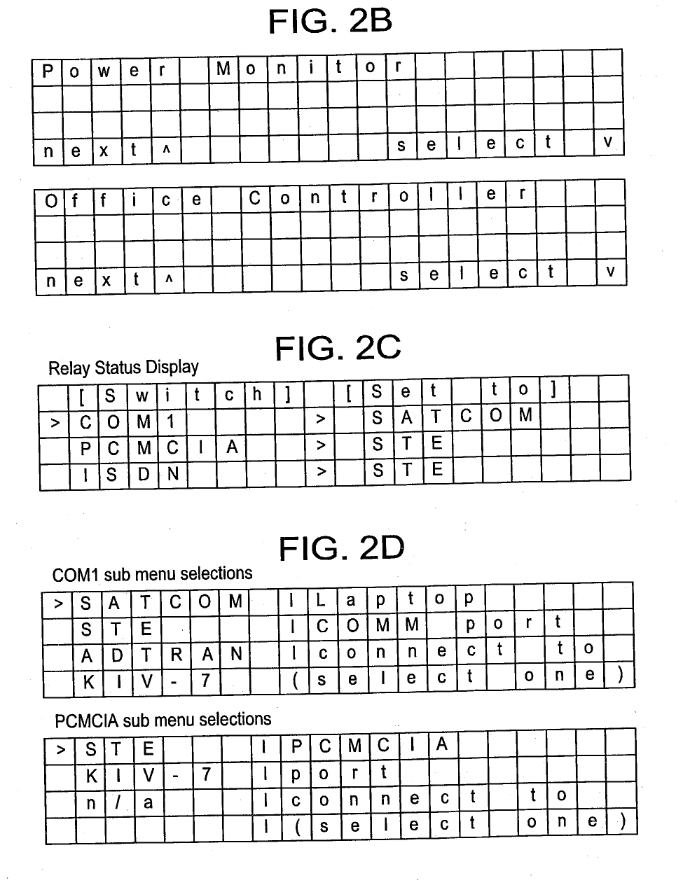

The display panel may display, for example, the power status such as back-up battery capacity, state of the internal battery charger, and the monitoring of an external connection to AC or DC power. Preferably such information is presented on the LCD at all times when no other module is being controlled by the display and any button keys. Examples of LCD screens are shown in FIGS. 2A-D. FIG. 2A shows a power monitor display that includes information on whether the system is plugged into an AC power source and/or a DC power source (shown in the last two columns on the right), the status of the battery charger (second row), the percent of charge remaining (third row) and the state of the battery charger (fourth row) where a star (*) indicates that the battery is charging in a constant current mode, a dot indicates the battery is discharging with no charger operation, and an exclamation point indicates that the battery has reached full charge and the charger is maintaining flow charge in a constant voltage mode. In an illustrative embodiment, a plurality of battery packs is installed in the system and each battery pack is allotted one character of space. The status of each power pack may be displayed individually.

FIG. 2B shows the mode selection menus for a power monitor and office controller. FIG. 2C shows a relay configuration when the VOC is selected. The switch refers to the relay set controlling the designated item such as a COM I port, PCMCIA (RS530) port, or an ISDN port. The greater than symbol (>) on the far left is the cursor, which moves down as a user tabs through the choices or depresses a NEXT button. This allows the operator to select the desired relay set to change settings. The operator may then select a relay set by, for example, depressing a SELECT button or pressing ENTER. Once a desired relay set is selected, the operator may select which connection to use for the relay. FIG. 2D shows an illustrative example of menus that may be used to select which connection to use for a relay. The user may tab through the selections or depress a NEXT button to make his/her selection. The operator then selects his/her choice by depressing a SELECT button or pressing ENTER to automatically change the relays to new settings. The relay status may then be updated with the new switch settings.

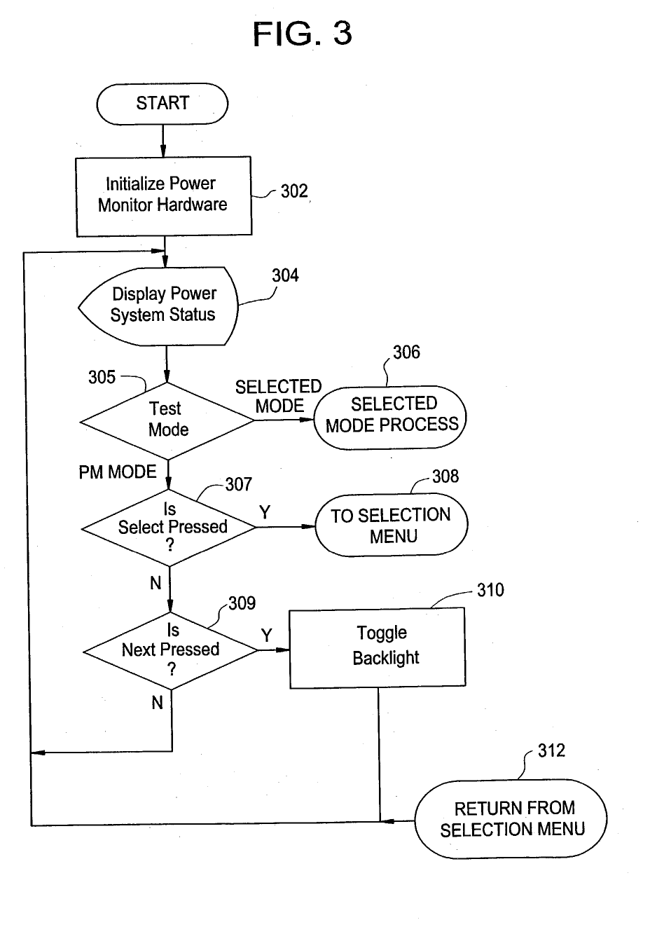

FIGS. 3-5 are display and control panel flowcharts according to illustrative embodiments of the invention. These flowcharts represent illustrative operations of control and menu functions of the power monitor and VOC as used in a modular satellite communications system. The flowcharts show only use with a power monitor and VOC, however, other devices may be incorporated and provided access to the LCD.

FIG. 3 shows the primary decision flow for a power monitor function. In step 302 the power monitor hardware is initialized. The power system status is then displayed in step 304. A test mode is run in step 305. A mode is selected, and the selected process is run in step 306. A user selects a function in step 307, such as power monitor or VOC. The user may continue to tab through function selections by pressing a NEXT button or by other means in step 309. If the NEXT button is pressed in step 309, a backlight is toggled in step 310. If a NEXT button has not been pressed in step 309, the power system status is again displayed in step 304 and the steps are repeated. Upon returning from the selection menu in step 312 the power system status is again displayed in 304 and the steps continue, as described above.

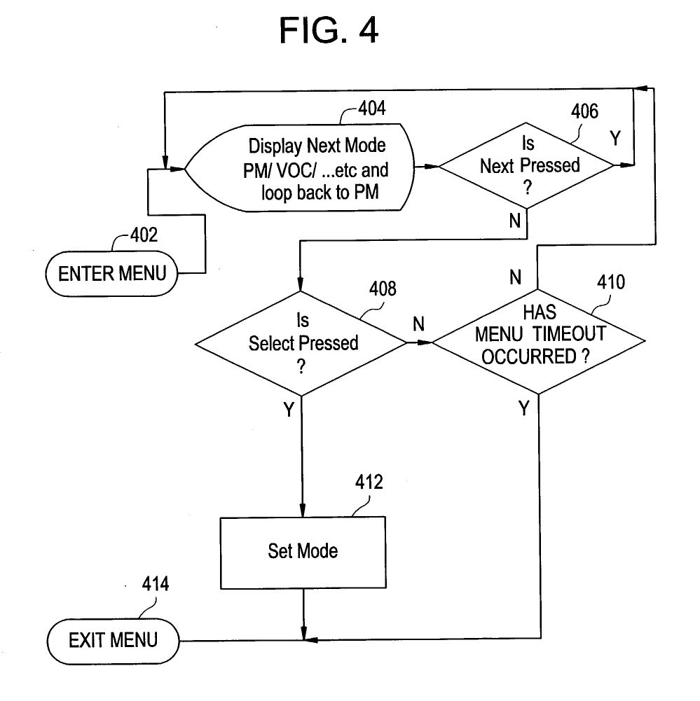

FIG. 4 shows a flowchart of actions in a power monitor menu system to select an alternate control function. The chart shows only the power monitor and VOC devices, however the menu and control functions can be extended to other devices, if desired. In step 402 the power monitor menu is accessed. A list of possible modes is displayed in step 404. A user may then either press a NEXT button in step 406 to advance to the next mode, or press a SELECT button in step 408 to select the highlighted mode. If no selection is made in step 408, then, provided that the menu has not timed out in step 310, the sequence returns to step 404 and 406 where the user may depress the NEXT button to move to a different mode. If the SELECT button has been pressed in step 408, then in step 412 the mode is set. The menu may then be exited in step 414.

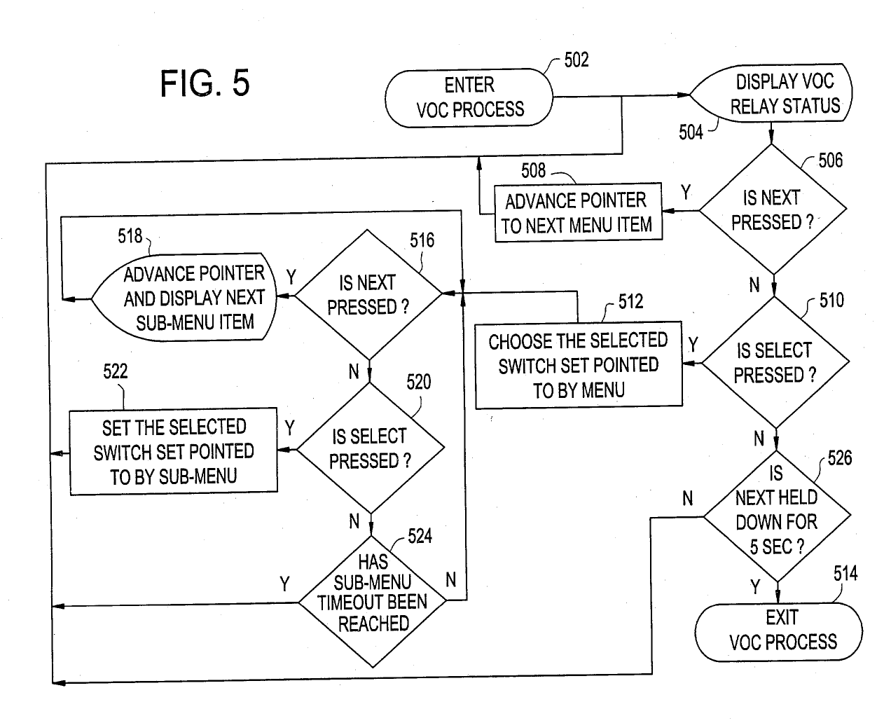

FIG. 5 shows control actions of a VOC as set by the LCD and control panel. The VOC can also be controlled by OSCP software described above. The VOC process begins in step 502. In step 504 a VOC relay status is displayed. In steps 506 and 508 a user may tab through menu items. When the desired menu item is reached a user may then select the item in step 510. In step 512 the selected switch set may be chosen. By holding the NEXT button down for a set amount of time in step 526, the VOC process will exit in step 514. If no selection is made and the system is not exited, the process loops back to step 504 where the VOC relay status is displayed. After step 510, a sub-menu is displayed. A user may tab through the sub-menu in steps 516 and 518 and select sub-menu items in steps 520 and 522. A sub-menu time-out feature may be included as shown by step 524. If no selection is made within a set time period, the process loops back to step 504 in which the VOC relay status is displayed. If the sub-menu time-out period has not been reached, the process loops back to step 516.

The OSCP is preferably a Windows-based program that runs on a PC or laptop computer. The program may be used to control a relay controller, referred to here as a VOC. The OSCP software sends messages to the VOC via connection to two control lines on the laptop serial port. In an illustrative embodiment the messages are control signals using data terminal ready (DTR) and request to send (RTS) lines designed to keep the serial port free for use with the communications equipment in a non-interfering way.

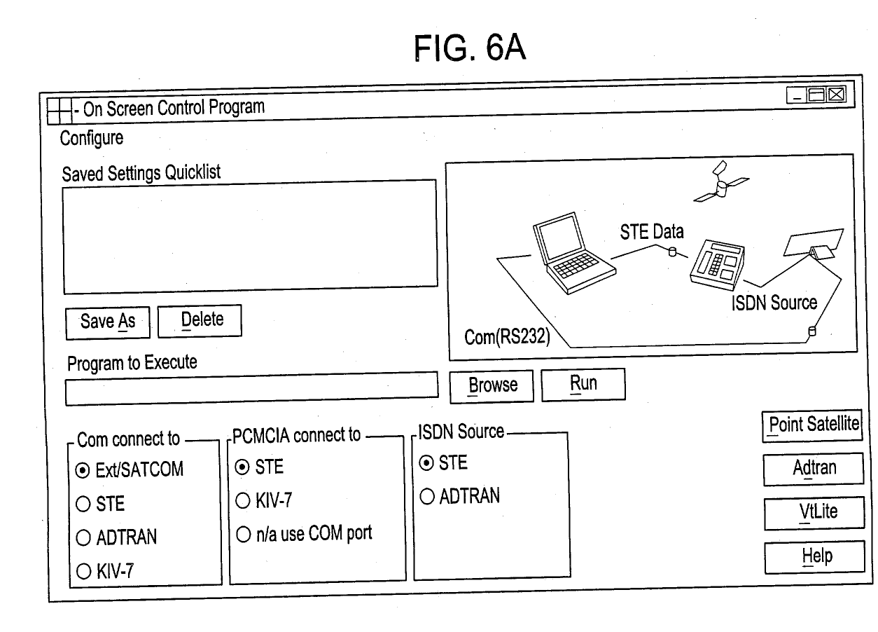

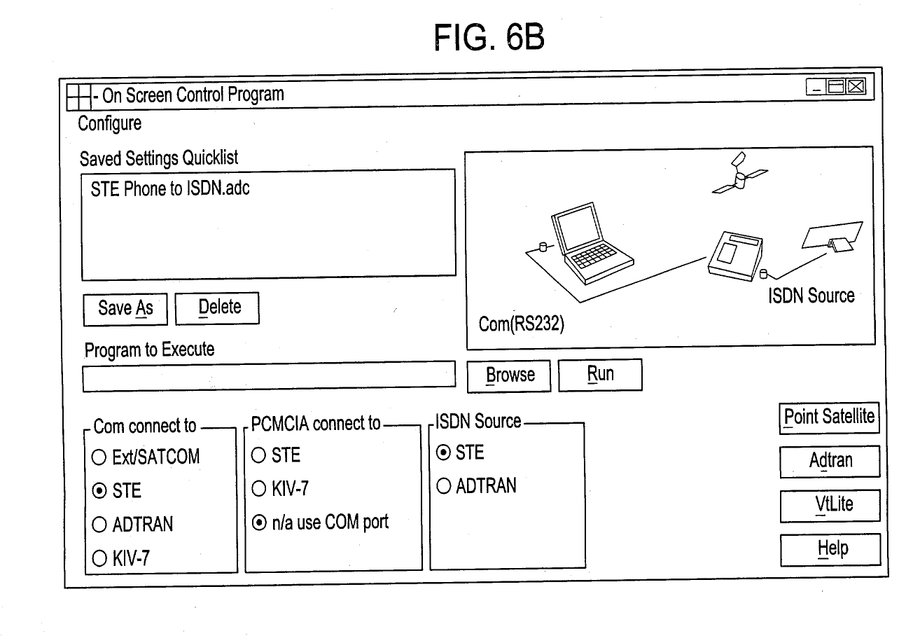

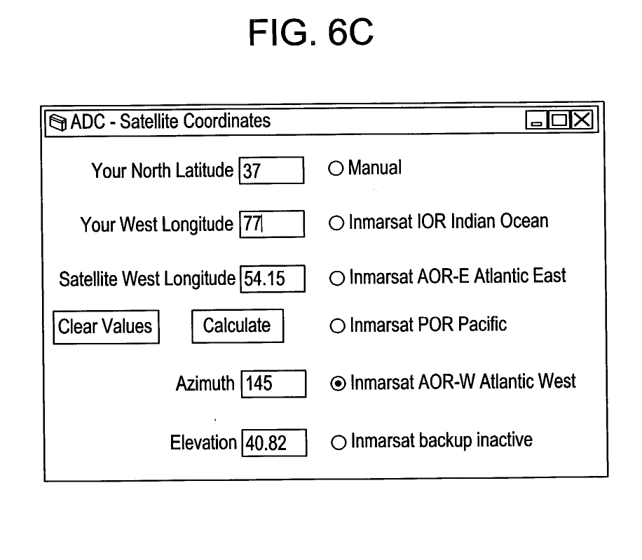

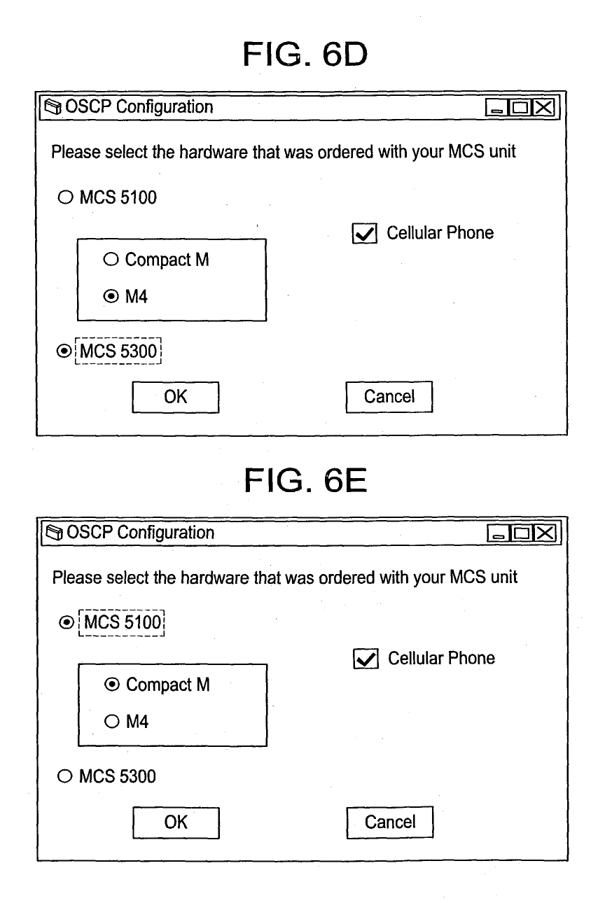

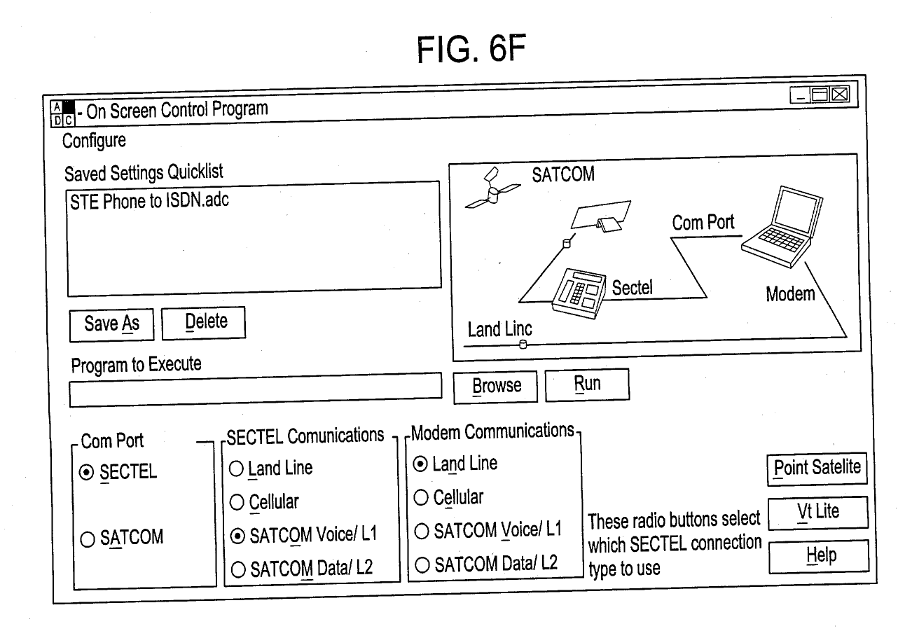

FIGS. 6A-F depict illustrative display screens for the OSCP software. FIG. 6A shows an opening display comprising a control panel having radio buttons to make selections for the VOC communications relays. A graphical display is included showing the current data path set by the VOC. The graphical display shows the operator how the equipment is connected by the relays. FIG. 6A shows connection of three components including an Ext/SATCOM, STE, and a second STE as an ISDN source. A component configuration may be saved as shown in FIG. 6B by pressing the SAVE AS button. This provides a quick recall of a particular setting. In FIG. 6B the Laptop serial port is connected to the STE telephone data port, and the STE ISDN is connected to a satellite terminal. The Quicklist box in the upper left hand portion of the screen shows the configuration that is saved. When the program is run at a later time, the Quicklist is shown with any preset settings and can be instantly selected to place the system back to a desired set-up. The Quicklist continues to grow as new items are added. When the available space is filled, the box becomes a scrollable list.

If desired, an external program such as a special communication program can be automatically selected and executed by placing a link to the program in the “Program to Execute” box. The program may be selected with the “Browse” button if desired. The “Run” button will cause the program to be executed when pressed. A “Point Satellite” button may be provided to assist with pointing the satellite terminal toward the satellite.

FIG. 6C shows a display of the calculator window. This display is accessed when the “Point Satellite” button is pressed. The user enters the system's approximate latitude and longitude. Radio buttons may be provided to select from preset INMARSAT satellites, which then automatically insert the Satellite West Longitude (sub-point). The program may also automatically calculate the antenna pointing azimuth and elevation. If desired, the user may manually enter the satellite sub-point, for some other geo-stationary satellite and perform the same calculations. A “Clear Values” button may be provided to clear the screen in order to enter new coordinates. By depressing the “Calculate” button, the azimuth and elevation may be recalculated.

Additional functions may be provided to assist with equipment configurations using the OSCP software. Particular software specific to a component such as the terminal may be accessed. For example, a button may be employed to automatically bring up VTLITE software to be used with a NERA M-4 INMARSAT terminal. The button would be rendered active only if the software was preinstalled on the computer. In an illustrative embodiment, communication with the M-4 terminal is via the Laptop serial port. The serial port will automatically be pre-selected if this action is activated.

In a further illustrative embodiment, a function may be included to bring up a Windows Hyperterminal program to allow communication with a computer via a serial port. If the port has not been pre-selected, then the program will automatically configure itself to connect to the installed computer. This assumes that the equipment is present in the system. A printer or other peripheral components may be included in the system.

The OSCP software may be used with different equipment. To do so, a user would select the type of equipment being used from a screen such as that depicted in FIGS. 6D-E.

FIG. 6F shows another illustrative opening display for the OSCP. This display differs from that depicted in FIG. 6B primarily in the selection of components. This screen provides different relay choices and a different mix of communication paths as compared to those provided by the FIG. 6B screen.

Using a configuration menu, such as depicted in FIGS. 6B and 6F, allows a single OSCP software installation to be easily adapted to different hardware systems. The following is an illustrative example of operation of the controlling software in conjunction with the VOC and LCD screen. When the radio buttons are pressed the OSCP sends commands to the VOC board. The relays are automatically set to achieve the desired connections. At the same time, the VOC will send messages to the LCD screen (if enabled by the power monitor), to update the LCD screen relay settings display. If the power monitor has not enabled the LCD for the VOC, then the relays will still be set as desired by the OSCP. The next time the user switches the display panel modes to the VOC the new settings will be displayed.

In an exemplary embodiment of the invention the VOC stores the settings in a non-volatile memory so that the next time power is applied, the relays will be preset to the previous settings. This allows the system to quickly be placed back in operation at the previous setting in the event of a power outage.

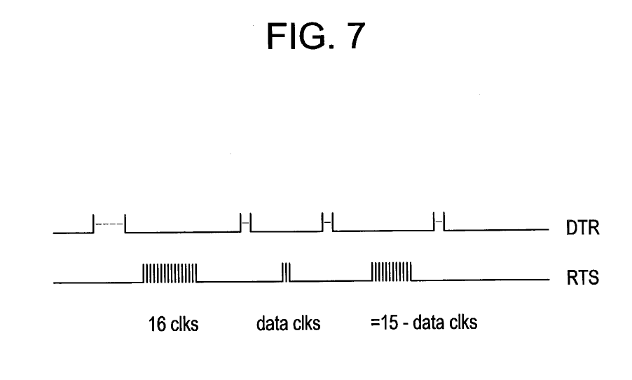

FIG. 7 depicts an illustrative example of logic levels for the operation of the VOC controller interfacing to the host computer via the serial port control lines DTR and RTS. These two lines are used to send a coded message to the controller to select the desired relay combinations.

The action from the host is to use the DTR signal as a flag to the controller to read any data that was toggled onto the RTS line. The data is sent with the RTS line as a count, with a range of 0-15 that the controller reads on its counter input line, attached to the RTS line.

The illustrative process corresponding to FIG. 7 is as follows:

1. Toggle the DTR line and perform a dummy read, discard value. This causes the VOC to clear the counter to 0.

2. The RTS line will then be toggled 16 times by the host.

3. Toggle the DTR line and read the count value of 16. (fixed preamble code) The counter is automatically reset when the counter value is read.

4. The RTS line will then be toggled x times by the host. Where x=command value.

5. Toggle the DTR line and read the command value.

6. The RTS line is then toggled (15−x) times by the host.

7. Toggle the DTR line and read the check value.

8. Validate the data read by testing the result of the true data and the complemented data. The result of the sum of the command with its complement should equal 15.

9. Then select the action to perform using the validated command value to jump through a table of possible relay configurations.

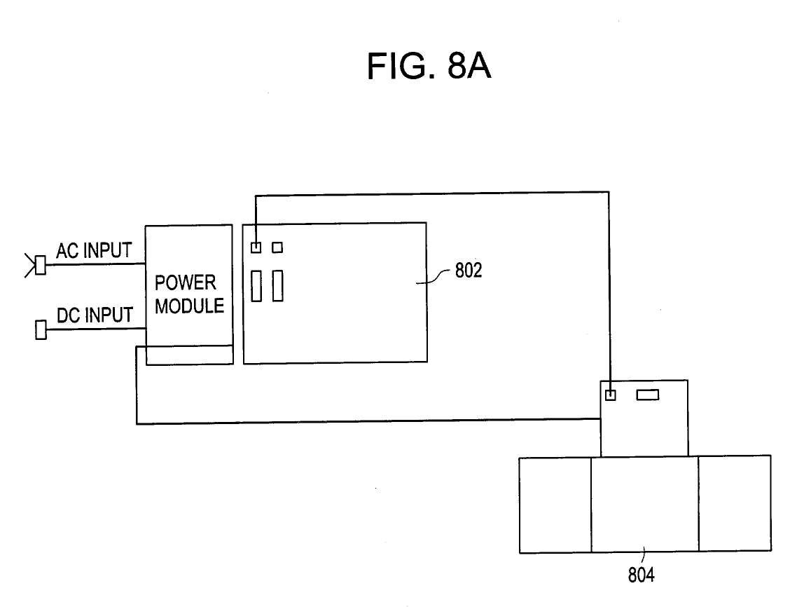

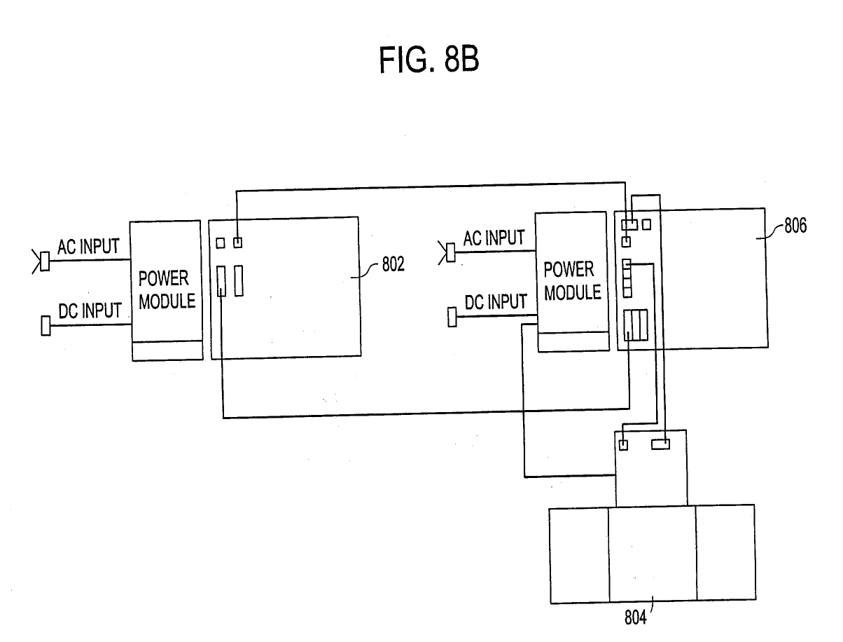

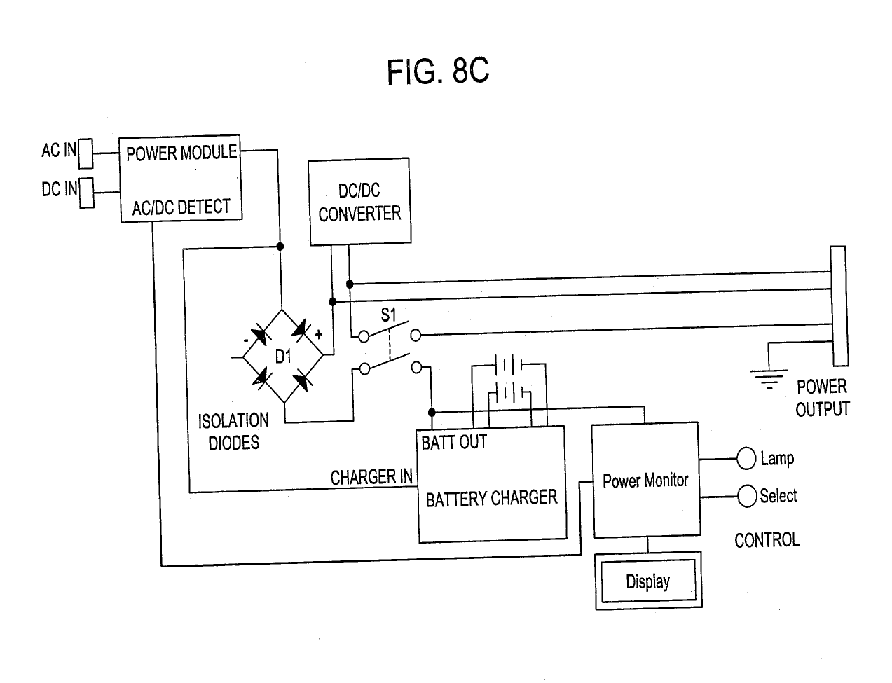

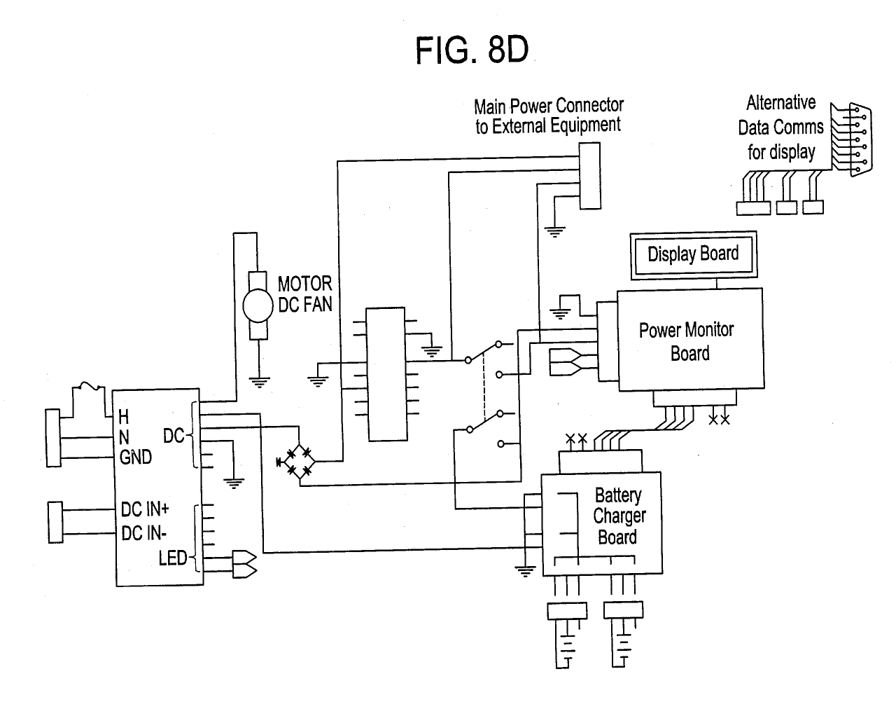

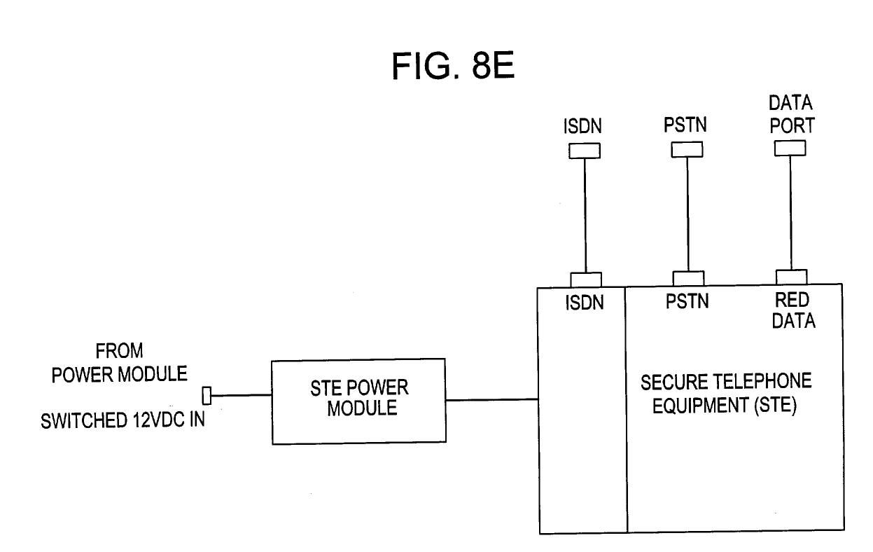

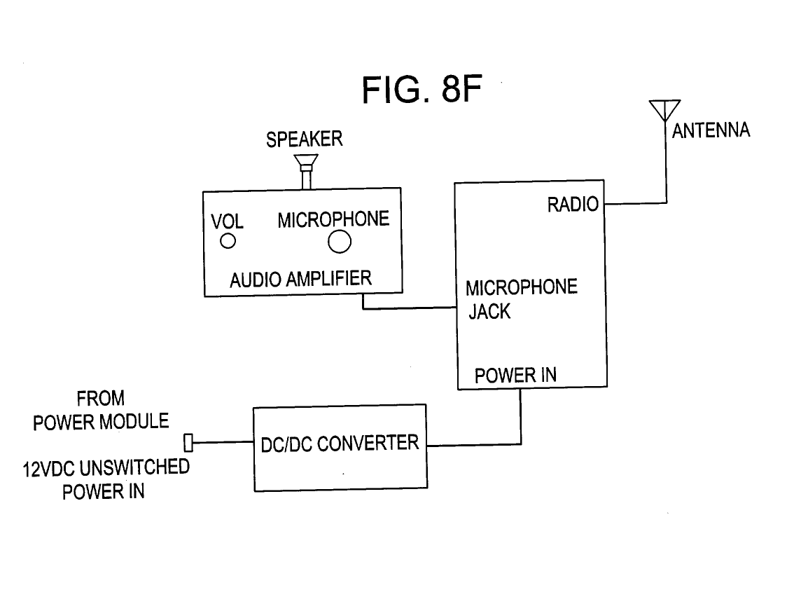

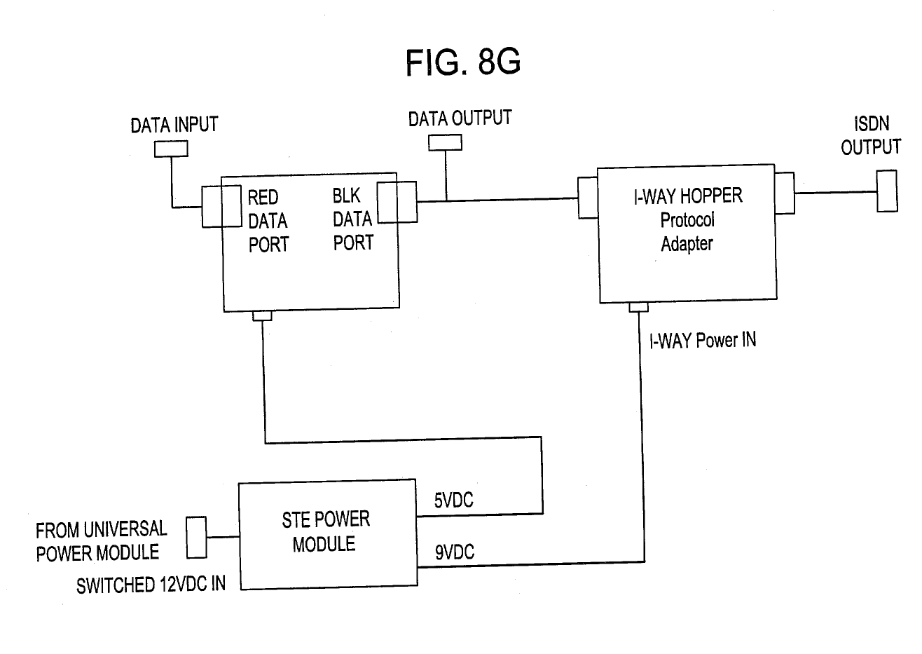

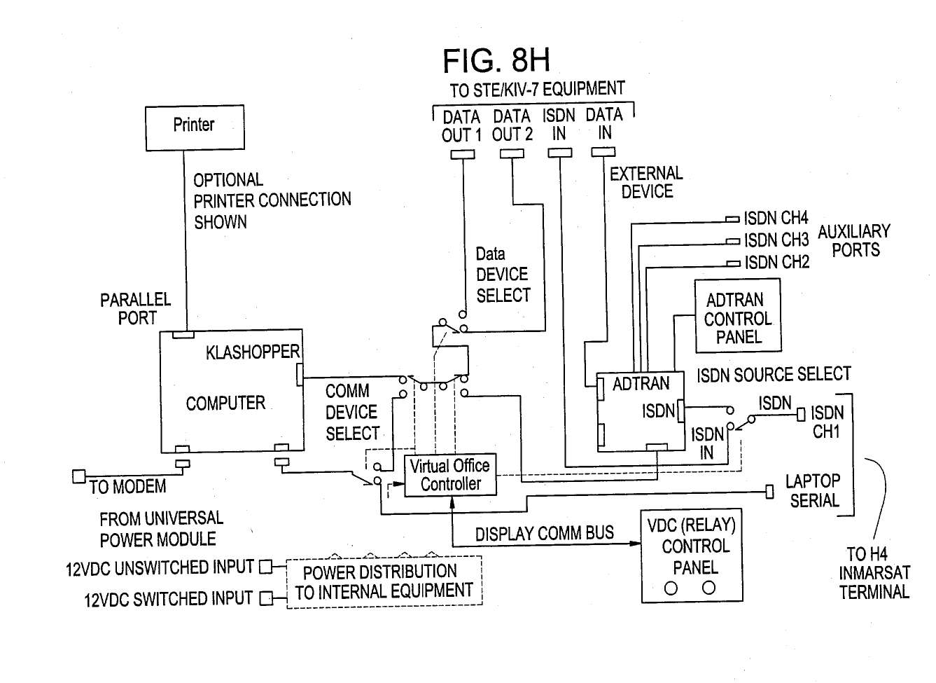

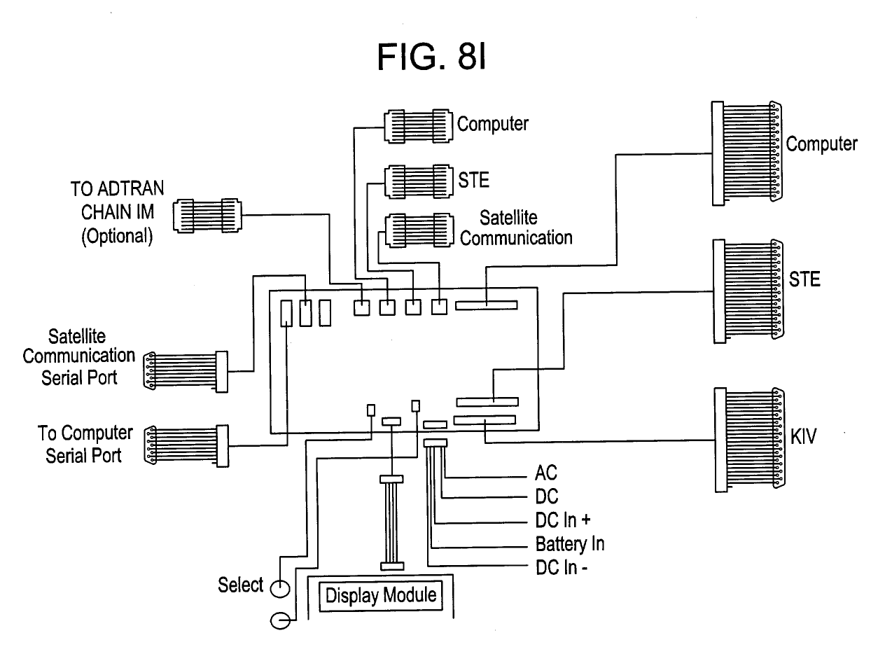

FIGS. 8A-K depict electrical schematics according to illustrative embodiments of the invention. FIGS. 8A-8B illustrate equipment connections for a module 802. FIG. 8A shows a terminal 804 connected to module 802, such as a secure telephone equipment module. FIG. 8B depicts module 802 connected to a computer 806 and terminal 804.

FIG. 8C shows a universal power module with a back-up power supply. FIG. 8D depicts a power subsystem.

Each of FIGS. 8E-H illustrates a different module insert. FIG. 8E shows a secure telephone equipment module, FIG. 8F depicts a military satellite transceiver module, FIG. 8G depicts a data encryption module, and FIG. 8H depicts a computer module.

FIGS. 8I and 8J depict VOC wiring and relays, respectively, and FIG. 8K shows a power pack module.

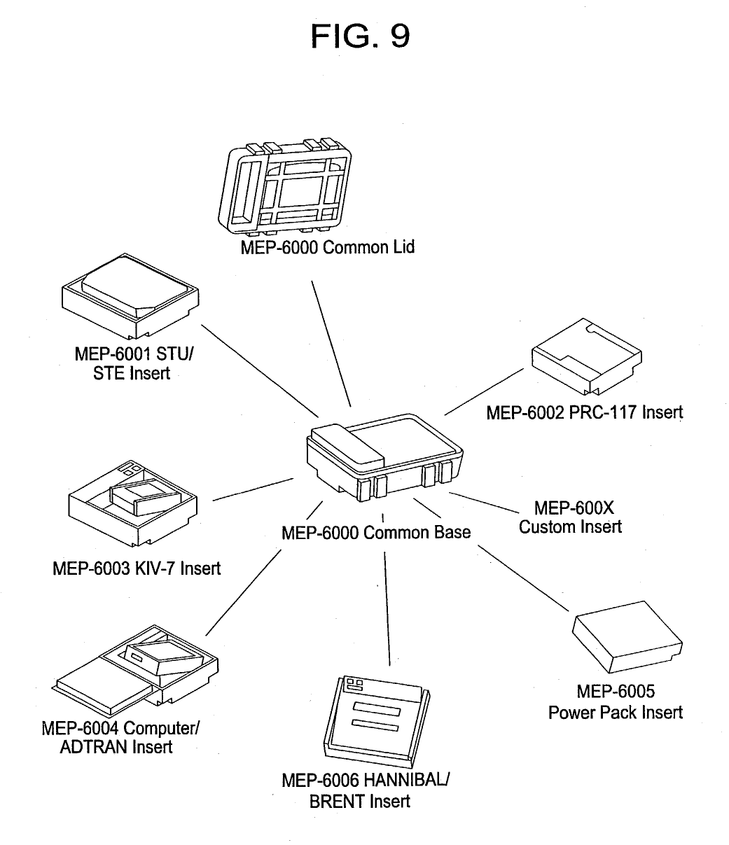

FIG. 9 depicts an illustrative embodiment of a modular satellite communications system. Included is a common base and numerous modular inserts that are automatically configured via OSCP software that manages the VOC relay bank. Those skilled in the art will understand that the modularity concept, including the inserts, relay bank and software may be applied to electronic equipment other than satellite communications equipment.

While the invention has been described by illustrative embodiments, additional advantages and modifications will occur to those skilled in the art. Therefore, the invention in its broader aspects is not limited to specific details shown and described herein. Modifications, for example, to the types of modules, relay bank configuration and OSCP software, may be made without departing from the spirit and scope of the invention. Accordingly, it is intended that the invention not be limited to the specific illustrative embodiments but be interpreted within the full spirit and scope of the appended claims and their equivalents.

Claimed is:

1. A satellite communications system comprising:
a relay bank;
a plurality of system modules, each providing one or more satellite communications functions; and
a computer readable medium to manage the relay bank to functionally configure the one or more modules.

2. The system of claim 1 wherein the modules are selected from the group consisting of voice, video, combination voice and video, data, facsimile, combination data and facsimile, printer, terminal, computer and combinations thereof.

3. The system of claim 1 wherein the satellite communications functions are provided by a wireless mechanism.

4. The system of claim 3 wherein the wireless mechanism is selected from the group consisting of cellular technology, international maritime satellite, and tactical satellite radio.

5. The system of claim 1 wherein the communications functions are secure.

6. A method of configuring satellite communications equipment wherein the equipment includes a relay bank and modules having one or more satellite communications functions, the method comprising:
designating one or more modules to be functionally configured;
providing signals based on the module selection to the relay bank to automatically functionally configure the modules.

7. A computer readable medium programmed to configure satellite communications equipment, the equipment including modules having one or more satellite communications functions and a relay bank, wherein the computer readable medium provides signals to the relay bank to automatically functionally configure the modules.

8. A computer configured to provide signals to a relay bank to automatically functionally configure satellite communications equipment modules, wherein the modules have one or more satellite communications functions.

9. A computer data signal embodied in a transmission medium to automatically functionally configure satellite communications equipment modules, wherein the modules have one or more satellite communications functions.
